(19) United States
(12) Patent Application Publication
(10) Pub. No.: US 2024/0264564 A1
(43) Pub. Date: Aug. 8, 2024

(54) OPTICAL SYSTEM FOR FLOATING HOLOGRAMS

(71) Applicant: Carl-Zeiss Jena GmbH, Jena (DE)

(72) Inventors: Siemen KÜHL, Jena (DE); Marc JUNGHANS, Jena (DE)

(73) Assignee: Carl-Zeiss Jena GmbH, Jena (DE)

(21) Appl. No.: 18/557,193

(22) PCT Filed: Apr. 27, 2022
(86) PCT No.: PCT/EP2022/061197

§ 371 Date: Oct. 25, 2023

(30) Foreign Application Priority Data
Apr. 27, 2021 (DE) 10 2021 110 734.2
Aug. 19, 2021 (DE) 10 2021 121 550.1
Sep. 10, 2021 (DE) 10 2021 123 515.4

(51) Int. Cl. G03H 1/22; G02B 5/32; G02B 27/09

(52) U.S. Cl. CPC G03H 1/22; G02B 5/32; G02B 27/0944; G03H 2222/34; G03H 2223/16; G03H 2223/24; G03H 2223/52

(57) ABSTRACT

An optical system comprises an imaging holographic optical element, which produces a floating hologram. An upstream light-forming holographic optical element causes spectral filtering of the light.

### RELATED APPLICATIONS

This application is a U.S. National Stage Application of International Application No. PCT/EP2022/061197, filed Apr. 27, 2022, which claims priority from German Patent Application Nos. DE102021110734.2, filed on Apr. 27, 2021, DE102021121550.1, filed on Aug. 19, 2021, and DE102021123515.4 filed on Sep. 10, 2021, all of which are hereby fully incorporated herein by reference.

### FIELD OF THE INVENTION

Various examples relate to a system comprising a plurality of holographic optical elements for generating a floating hologram.

### BACKGROUND OF THE INVENTION

Techniques for generating a floating hologram by means of an imaging holographic optical element (HOE) are known. Such a floating hologram is generated in a volume arranged outside of the imaging HOE. This means that the hologram is arranged offset from the imaging HOE. This can generate an optical “floating effect”; the hologram stands freely in space.

It has been established that holograms with a great depth or great distance from the imaging HOE place particularly high demands on the quality of the illumination of the imaging HOE.

### SUMMARY OF THE INVENTION

Accordingly, it is an object of the invention to provide an optical system which is able to generate a high-quality floating hologram. It is also an object of the invention to provide a compact optical system which is able to form a floating hologram.

This object is achieved by the features of the independent patent claims. The features of the dependent patent claims define embodiments.

According to various examples, a system made of a plurality of HOEs is used to generate a high-quality hologram. In particular, use can be made of an imaging HOE which, as a result of a suitable exposure, is configured such that it generates a hologram with a desired motif upon a subsequent illumination. Further, use can be made of a light-shaping HOE; the light used to illuminate the imaging HOE can be shaped by the light-shaping HOE.

An optical system therefore comprises an imaging HOE. The imaging HOE is configured to generate a floating hologram on the basis of light. This floating hologram is arranged in a volume outside of the imaging HOE. Further, the optical system comprises a light source. The light source is configured to transmit the light along a beam path to the imaging HOE. The optical system also still comprises a light-shaping HOE. The latter is arranged in the beam path between the light source and the imaging HOE and is configured to apply one or more light-shaping functionalities to the light.

In this case, very different light-shaping functionalities can be provided as a matter of principle, for instance on an individual basis or else cumulatively. By way of example, exemplary light-shaping functionalities include: spectral filtering, which is to say a selection of a smaller wave-length range of the incident light; filtering in the angular space, which is to say for example a selection of a smaller angular spectrum with which the light propagates along the beam path; and an arrangement of the light in position space, for example to thus deflect the light to the imaging HOE and/or illuminate the imaging HOE homogeneously.

A method for producing an optical system comprises the provision of an imaging HOE. The latter is configured to generate a floating hologram on the basis of light. The floating hologram is arranged in a volume outside of the imaging HOE. Moreover, the method comprises the provision of a light source. The latter is configured to transmit the light along a beam path to the imaging HOE. The method also comprises the provision of a light-shaping HOE. The latter is arranged in the beam path between the light source and the imaging HOE and configured to apply one or more light-shaping functionalities to the light.

The features set out above and features that are described hereinbelow can be used not only in the corresponding combinations explicitly set out, but also in further combinations or in isolation, without departing from the scope of protection of the present invention.

### BRIEF DESCRIPTION OF THE DRAWINGS

FIG. 1 is a schematic view of an optical system according to various examples, which comprises a light-shaping HOE and an imaging HOE connected in series along a beam path of light.

FIG. 2 illustrates an exemplary realization of the optical system from FIG. 1 according to various examples.

FIG. 3 illustrates spectral filtering, which may be provided by the light-shaping HOE according to various examples.

FIG. 4 illustrates an exemplary realization of the optical system from FIG. 1 according to various examples.

FIG. 5 illustrates an exemplary realization of the optical system from FIG. 1 according to various examples.

FIG. 6A illustrates an exemplary integration of an optical system according to various examples into an interior trim panel of a motor vehicle.

FIG. 6B is a perspective view of the realization of the optical system from FIG. 2.

FIG. 7 is a flowchart of an exemplary method.

FIG. 8 is a schematic view of an optical system according to various examples, which comprises a light-shaping HOE and an imaging HOE connected in series along a beam path of light, and also comprises an optical waveguide.

FIG. 9 is a perspective view of an exemplary realization of the optical system from FIG. 8 according to various examples.

FIG. 10 is a side view of an exemplary realization of the optical system from FIG. 8 according to various examples.

FIG. 11 is a schematic view of an optical system according to various examples, which comprises a plurality of optical channels.

FIG. 12 is a schematic view of an optical system according to various examples, which comprises a plurality of optical channels.

FIG. 13 is a schematic view of an optical system according to various examples, which comprises a plurality of optical channels.

FIG. 14 is a perspective view of an exemplary realization of the optical system from one of FIGS. 11 to 13 according to various examples.

FIG. 15 is a perspective view of an exemplary realization of the optical system from one of FIGS. 11 to 13 according to various examples.

FIG. 16 is a side view of an exemplary realization of the optical system from one of FIGS. 11 to 13 according to various examples.

FIG. 17 is a perspective view of the realization of the optical system from FIG. 16.

FIG. 18 is a perspective view of an exemplary realization of the optical system from one of FIGS. 11 to 13 according to various examples.

FIG. 19 is a perspective view of the realization of the optical system from FIG. 18.

FIG. 20 schematically illustrates a controller for a plurality of optical channels according to various examples.

FIG. 21 is a flowchart of an exemplary method.

### DETAILED DESCRIPTION OF INVENTION

The properties, features and advantages of this invention described above and the way in which they are achieved will become clearer and more clearly understood in association with the following description of the exemplary embodiments which are explained in greater detail in association with the drawings.

The present invention is explained in greater detail below on the basis of preferred embodiments with reference to the drawings. In the figures, identical reference signs denote identical or similar elements. The figures are schematic representations of various embodiments of the invention. Elements illustrated in the figures are not necessarily illustrated as true to scale. Rather, the various elements illustrated in the figures are rendered in such a way that their function and general purpose become comprehensible to a person skilled in the art.

Techniques which make it possible to generate a floating hologram are described herein-below. The hologram can reproduce an image motif, for instance a button or an information sign. The hologram could also reproduce a plurality of image motifs. By way of example, an image could be assembled from a plurality of image motifs, or separate image motifs could be reproduced.

To this end, an optical system comprising a plurality of HOEs is used.

The hologram generated by means of a corresponding optical system may have a particularly high floating height and/or a particularly large depth effect. By way of example, a distance between a volume, in which the hologram is depicted in the case of a suitable illumination of an imaging HOE, and the imaging HOE could be no less than 60% of the lateral dimensions (perpendicular to the distance) of a refractive index-modulated region of the imaging HOE.

The hologram may have one or more image motifs as a matter of principle. The various image motifs can be produced by light which has run through different beam paths.

The imaging HOE can be realized as a volume HOE, which is to say it may have a variation of the refractive index in 3-D. A corresponding refractive index-modulated region has a 3-D extent. This variation of the refractive index refracts the light with a diffraction pattern, whereby the hologram is formed. The volume HOE is delimited from a surface HOE, in which a modulation of the surface of a substrate brings about the diffraction pattern. By way of example, the surface could be wavy.

The imaging HOE can be realized as a transmission HOE or as a reflection HOE. In the case of a transmission HOE, the refractive index-modulated region is illuminated from one side and the hologram is generated in a volume facing the opposite side. In the case of reflection HOEs, the refractive index-modulated region is illuminated from one side and the hologram is generated in a volume facing the same side.

For example, it would be possible that the beam path of the light is incident on the imaging HOE in edge lit geometry. This means that the imaging HOE comprises a substrate (made of a transparent material which is optically denser than air), to which the refractive index-modulated region has been applied. The beam path is coupled into the substrate on the narrow side and then passes through the substrate—e.g., glass or polymethylmethacrylate—before it is incident on the refractive index-modulated region. Typically, the substrate has a layer thickness that is substantially greater than the layer thickness of the refractive index-modulated region. The so-called re-construction angle denotes the angle at which the light is incident on the refractive index-modulated region. The latter may be arranged along a surface of the imaging HOE. Light not diffracted by the refractive index-modulated region for the purpose of generating the hologram can then experience total-internal reflection at the surface of the imaging HOE and be reflected back into the substrate.

It would be conceivable in some variants for an absorbent material to absorb such back-reflected light (beam dump); as a result, the reproduction of the hologram is not disturbed by “background light”.

However, in other examples, it would also be conceivable for the substrate to realize an optical waveguide. Then, the light reflected back at the surface of the imaging HOE is reflected at a further surface of the optical waveguide, and it is incident again on the imaging HOE. Thus, the optical waveguide may be arranged below the imaging HOE and extend along the imaging HOE, and the light propagating in the optical waveguide can be used to fully illuminate the imaging HOE. In this case, the imaging HOE is applied to an outer surface of the optical waveguide. This enables a particularly compact design because the thickness of the substrate forming the optical waveguide can be less than the lateral dimensions of the imaging HOE. By way of example, it would be conceivable that a thickness of the optical waveguide perpendicular to the imaging HOE (i.e., along a direction extending away from the imaging HOE) is no more than 20% of a length of the imaging HOE along the optical waveguide.

The optical system may comprise a light source. The latter is configured to transmit the light along a beam path to the imaging HOE. For example, the beam path can be defined by the optical axis of the corresponding optical channel with the optical components. The light propagates along the beam path to the imaging HOE.

The light source preferably emits light in the visible spectrum, in particular between 380 nm and 780 nm.

One or more light-emitting diodes can be used as a light source in the various examples described herein. Light-emitting diodes are particularly simple, durable, and inexpensive and have sufficient optical properties, especially in relation to the coherence of the emitted light, with regard to a multiplicity of lighting functions, in particular holographic lighting functions. Light-emitting diodes are particularly efficient.

For example, a light-emitting diode could comprise a light emitter (active area emitting photons) with dimensions between 0.5×0.5 mm² and 1×1 mm². In particular, the use of small emitter surfaces for the aforementioned applications can be advantageous.

As a matter of principle, it is helpful if the reconstruction wave—i.e., the wavefront of the light during illumination—corresponds to the best possible extent with the reference wave when recording the hologram—i.e., with the wavefront of the light during the exposure. Exposure is implemented by lasers which in principle represent a point light source. Accordingly, it is advantageous if the LEDs used for reconstruction purposes have emitter surfaces that are as small as possible, and hence better meet the needs of the assumption of a point light source.

Various examples are based on the discovery that a further improvement of the illumination of the imaging HOE can be achieved by using a light-shaping HOE which is arranged in the beam path between the light source and the imaging HOE. Moreover, the optical system can also have a particularly compact embodiment, which is to say small external dimensions, as a result of using the light-shaping HOE.

The light-shaping HOE can realize various light-shaping functionalities. Overall, this can improve the illumination of the imaging HOE.

Some such light-shaping functionalities which can be provided by the light-shaping HOE are described hereinbelow in the context of tab. 1.

TABLE 1
Various light-shaping functionalities that may be provided by the light-shaping HOE.
A homogeneous angular and wavelength spectrum of the illumination of the imaging HOE
can be obtained by means of such light-shaping functionalities, with the result that
it is possible to reconstruct a hologram which has a great distance from the refractive
index-modulated region of the imaging HOE and which has a large depth of field.

| | Brief description | Exemplary details |
|---|---|---|
| I | Spectral filtering | The light-shaping HOE can be configured to perform spectral |
| | | filtering of the light. This means that light at specific wave- |
| | | lengths is transmitted by the light-shaping HOE in the direction |
| | | of the imaging HOE - by way of suitable diffraction - |
| | | while light at other wavelength is not transmitted in the direction |
| | | of the imaging HOE. |
| | | The details regarding the spectral filtering are explained here- |
| | | inbelow in the context of FIG. 3. |
| | | By way of such spectral filtering, it is possible to obtain |
| | | particularly monochromatic illumination or an illumination with |
| | | a comparatively narrow wavelength spectrum. This allows |
| | | the hologram to be generated with particularly high quality. |
| II | Filtering the angular | The light-shaping HOE can further be configured to filter the |
| | spectrum | angular spectrum of the light. The angular spectrum is |
| | | characterized by the shape of the wavefront of the propagating |
| | | light along the beam path. For example, a plane wave would |
| | | cause the imaging HOE to be illuminated from one angle only, |
| | | or would cause light to propagate along the beam path without |
| | | divergence. |
| | | In an example, a reduced divergence of the light along the |
| | | beam path can be generated by filtering the angular spectrum. |
| | | Thus, the light can be collimated. Virtually plane wave- |
| | | fronts of the light can be generated by reducing the divergence. |
| | | Post filtering, the angular spectrum could be for example less |
| | | than 2°, optionally less than 1° and further optionally less |
| | | than 0.5°. |
| | | Phrased more generally, the filtering allows the angular spectrum |
| | | to be brought into line with the angular spectrum of reference |
| | | light used during the exposure of the imaging HOE. |
| | | A particularly high-quality hologram can be generated by |
| | | such filtering in the angular space. |
| III | Light shaping in position | The light-shaping HOE can further be configured to steer the |
| | space | beam path of the light to the imaging HOE. |
| | | Compact designs of the optical system can be obtained as a |
| | | result. |
| | | The light-shaping HOE can be configured to homogeneously |
| | | illuminate the imaging HOE. Such a homogeneous illumination |
| | | of the imaging HOE can mean that, in particular, the entire |
| | | area of the imaging HOE is illuminated with predominantly |
| | | the same intensity of the light. Preferably, a deviation |
| | | in the intensity along the imaging HOE is less than 20%, |
| | | further preferably less than 10%, and particularly preferably less |
| | | than 5%. In particular, a ratio of minimum intensity (or minimum |
| | | illuminance or irradiance) to maximum intensity (or |
| | | maximum illuminance or irradiance) can be >0.8. |

In principle, various realizations for the light-shaping HOE are conceivable. By way of example, it would be possible for the light-shaping HOE to deflect the beam path in reflection geometry. That is to say, a reflection HOE can be used.

A reflection HOE is wavelength-selective, which is to say only light from a narrow wave-length spectrum is efficiently diffracted for a specific output angle. As a result, spectral filtering according to tab. 1: example 1 can be achieved. For example, a full width at half maximum of the wavelength spectrum of the light that is no greater than 10 nm, in particular no greater than 5 nm, could be obtained post spectral filtering. A better reconstruction of the image in the form of the hologram can be achieved as a result, because smearing and ghost images—which could otherwise arise in the case of a broadband illumination of the imaging HOE—are avoided.

Similar to what was described above in the context of the imaging HOE, it would be conceivable for the light-shaping HOE to be attached to an outer surface of an optical waveguide. The light-shaping HOE and the imaging HOE can be applied to different outer surfaces of the optical waveguide.

The optical system may have a plurality of optical channels in some examples. Each optical channel can at least be characterized by a corresponding beam path. Light assigned to the respective optical channel propagates along this beam path. The beam paths can be separated by stop elements. This means that the beam paths can be defined, for example, by the optical axes of specific optical elements of the respective optical channel, for instance by corresponding collimator lenses.

By way of example, each optical channel may have an assigned light-shaping HOE. The light-shaping HOEs of different optical channels may be formed by a common grating structure, which is to say different regions of the common grating structure are illuminated by the light from different optical channels. However, separate grating structures could also be used.

Each optical channel can optionally comprise an associated light source. However, in principle, it would also be conceivable that a light source provides light for a plurality of optical channels

It would be conceivable that a corresponding holographic lighting function is assigned to each optical channel. For example, the lighting function may comprise the display of an image motif, with the result that each optical channel reconstructs one or more image motifs. Furthermore, a common lighting function, for example an image motif extending over the entire hologram surface, may also be realized, with each channel accordingly reconstructing a portion of the common image motif. Thus, special holograms can be generated by the use of a plurality of optical channels. A corresponding controller may be provided, which is configured to separately or jointly control light sources of various optical channels. By way of example, it is possible to generate holograms that are able to display different motifs, for example depending on which optical channel is activated. By way of example, the controller can be configured to separately or jointly control light sources of different channels on the basis of a motif specification for an image motif of the hologram. It would also be conceivable that holograms with a flexibly adjustable brightness are generated, depending on how many optical channels are activated. Thus, the controller can be configured to separately or jointly control light sources of different optical channels on the basis of a brightness specification for an image motif of the hologram. In the process, it is thus possible to illuminate an overlap region of the imaging HOE with the light of a plurality of optical channels; then, a common image motif is reconstructed there, appearing brighter or darker depending on how many optical channels are activated.

In the process, there are different arrangement options for the optical channels. The channels can be arranged next to one another, with the result that a line-by-line or column-by-column reconstruction is made possible. This means that the beam paths of the various optical channels run parallel or perpendicular to one another, at least in partial regions. The optical channels can likewise be arranged in a grating structure, with the result that a line-by-line and column-by-column reconstruction is provided. Furthermore, the channels may also be arranged relative to one another in a diagonal direction or at further azimuthal angles. Thus, an angle between the beam paths can for example range from 45° to 90°.

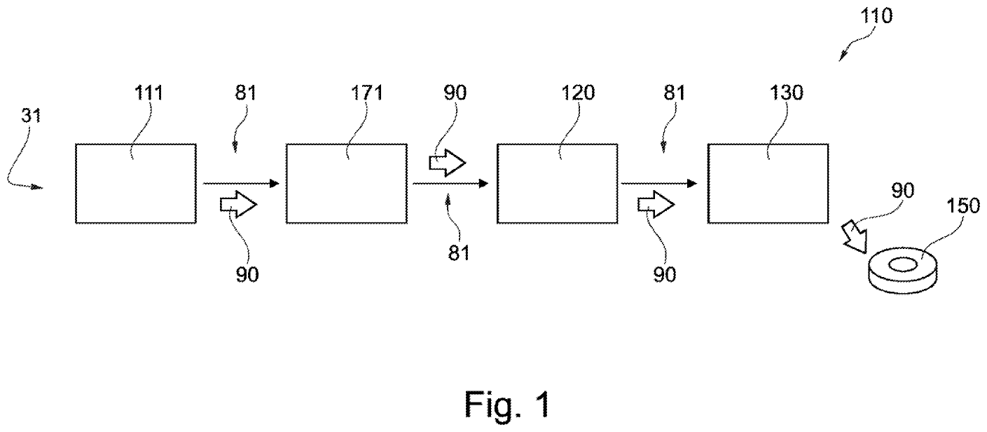

FIG. 1 illustrates aspects in connection with an optical system 110. FIG. 1 is a schematic illustration of the optical system 110, which is configured to generate a hologram 150.

The optical system 110 comprises a light source 111. The light source 111 can be realized by one or more light-emitting diodes. The light source 111 is configured to transmit light 90 along a beam path 81. The light 90 is used to generate the hologram 150. This defines a corresponding optical channel 31.

Various optical components 171, 120, 130 are arranged along the beam path 81.

By way of example, it would be possible for a refractive or mirror-optical optical element 171, 172 to be arranged adjacent to the light source 111 in the beam path 81 between the light source 81. This refractive or mirror-optical optical element is configured to collect the light 90. A greater light yield may be obtained as a result.

For example, the optical element 171, 172 could be realized by a concave mirror or a lens—i.e., a collimator lens.

The light 90 propagates onward along the beam path 81, in the direction of a light-shaping HOE 120. Various light-shaping functionalities which can be provided by the light-shaping HOE 120 were described hereinabove in the context of tab. 1.

The light 90—after being shaped by the light-shaping HOE 120—then propagates onward along the beam path 81, to an imaging HOE 130. The imaging HOE 130 is configured to generate the floating hologram 150 on the basis of light 90.

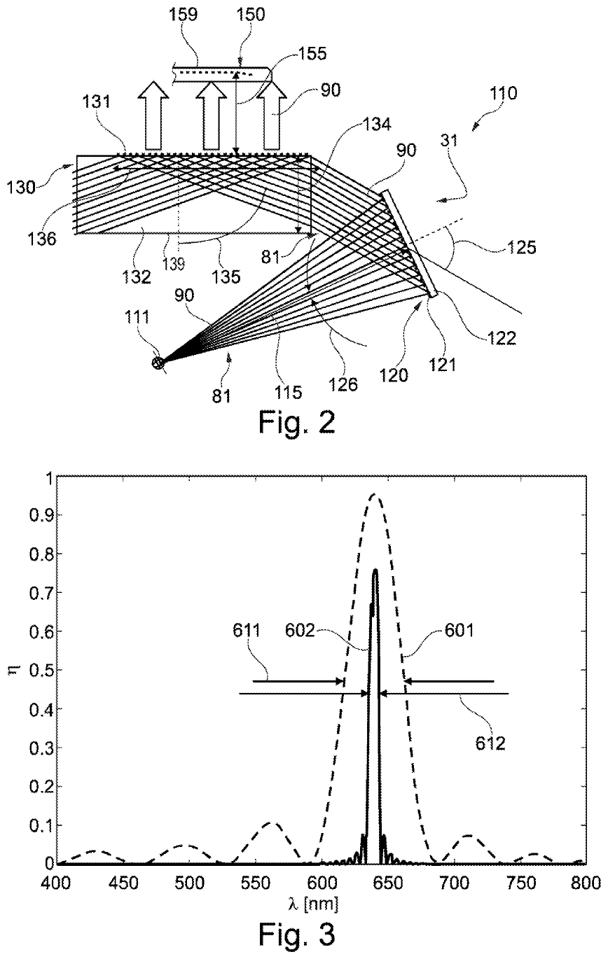

Various structural realizations of the optical system 110 are conceivable. Some realizations are described hereinafter, for example in the context of FIG. 2.

FIG. 2 illustrates aspects in connection with the optical system 110. In particular, FIG. 2 illustrates an exemplary structural realization of the optical system 110. In the example of FIG. 2, the optical system 110 comprises no refractive or mirror-optical optical element which would be arranged in the beam path 81 between the light source 111 and the light-shaping HOE 120.

The light source 111 transmits light 90 with a significant divergence, which is to say with a comparatively broad angular spectrum. FIG. 2 shows, by way of example, rays of light 90 along the beam path 81 (“ray tracing”).

The light 90 is incident on the light-shaping HOE 120. The light-shaping HOE 120 comprises a substrate 122 and a refractive index-modulated region 121. The light-shaping HOE 120 deflects light 90 along the beam path in reflection geometry.

The spectral filtering arises because reflection holograms, for example the reflection hologram 120, are wavelength-selective - which is to say light for a specific angle is only diffracted efficiently thereby for a certain range of wavelengths. The spectral filtering is also depicted in FIG. 3. FIG. 3 illustrates the efficiency of the diffraction in a specific solid angle, depending on the wavelength. Illustrated are the wavelength spectrum 601 of the incident light (depicted by the dashed line) and the wavelength spectrum 602 (solid line) of the diffracted light. The full width at half maximum 612 of the spectrum of the diffracted light is no more than 30%, optionally no more than 40%, and further optionally no more than 50% of the full width at half maximum 611 of the emission spectrum of the light source, which is to say the spectrum of the incident light. In particular, the full width at half maximum 612 of the diffracted light is no greater than 10 nm, and optionally greater than 5 nm.

Returning to FIG. 2 again: the light 90 incident on the imaging HOE 130 is more narrowband than the light 90 transmitted by the light source 111 as a result of the spectral filtering.

FIG. 2 also depicts the reflection angle 125, at which the light-shaping HOE 120 reflects the light along the beam path 81. Moreover, the angle of incidence 126 of light 90 on the light-shaping HOE 120 is also depicted. In this case, these angles 125, 126 correspond to the angles at which reference light is incident on the light-shaping HOE 120 during the exposure of the light-shaping HOE 120 from two different laser sources. This reflection angle 125 may correspond to the Brewster angle of the material of the substrate 122. This means that the light 90 which is deflected by the light-shaping HOE 120 is linearly polarized. By using the Brewster angle during the exposure, it is possible to avoid unwanted interactions on account of different polarizations of the light 90 during the exposure of the light-shaping HOE 120.

In this case, the angle of incidence 126—the angle of incidence 126 is 0° in the depicted example of FIG. 2, which is to say perpendicular to the incidence on the light-shaping HOE 120; however, other values would also be possible in principle—is chosen such that Fresnel reflections of the light 90 are oriented away from the imaging HOE 130. As a result, the quality of the illumination of the imaging HOE 130 can be additionally increased.

FIG. 2 also depicts what is known as a reconstruction angle 135. The reconstruction angle 135 denotes the direction along which the light 90 along the beam path 81 is incident on the refractive index-modulated region 131 of the imaging HOE 130. This reconstruction angle 135 is defined by the reflection angle 125, the relative arrangement of the light-shaping HOE 120 with respect to the imaging HOE 130, and the refraction at the interface of air to the substrate 132.

Then, the hologram 150 is generated on the basis of the light 90 in a volume 159 which is arranged at a distance 155 from the refractive index-modulated region 131 of the imaging HOE 130. Thus, a floating hologram 150 is generated.

The thickness 134 of the substrate 132 is dimensioned to be comparatively large in the example of FIG. 2. In particular, the thickness 134 of the substrate 132 is dimensioned such that the light 90 illuminates the entire lateral surface of the refractive index-modulated region 131 of the imaging HOE 130 without being reflected at a back side 139 of the substrate 132 distant from the imaging HOE 130. This means that no optical waveguide functionality is realized by the substrate 132 in the illustrated example of FIG. 2. For example, a light-absorbing material (a so-called “beam dump”) could be attached to the back side 139.

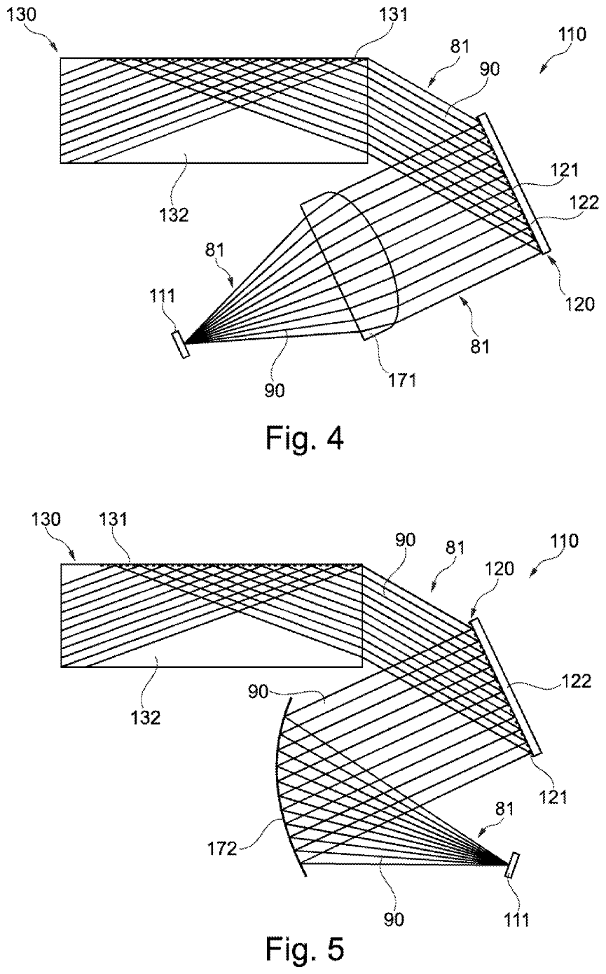

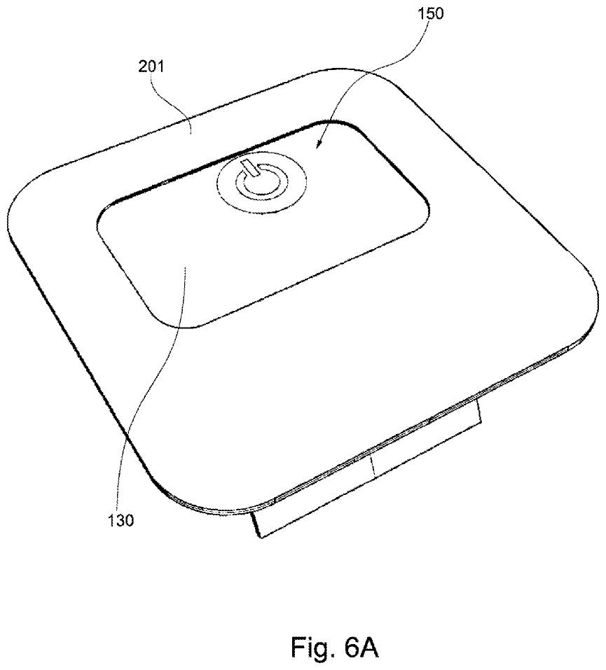

One or more further beam-shaping components can be arranged along the beam path 81 between the light source 111 and the light-shaping HOE 120 in various examples. By way of example, use could be made of a lens 171—cf. FIG. 4—or a mirror 172—cf. FIG. 5. The light yield can be increased as a result, which is to say a greater amount of light 90 transmitted by the light source 111 can be used to illuminate the imaging HOE 130.

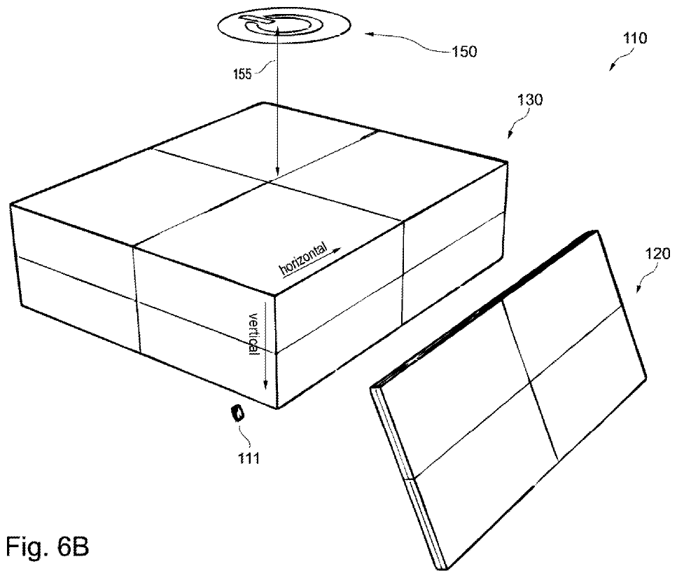

Such a refractive or mirror-optical optical element 171, 172 arranged in the beam path 81 between the light source 111 and the light-shaping HOE 120 can collect/shape the light in the horizontal and/or vertical direction. In this case, “vertical” denotes a direction in the plane of the drawing; “horizontal” denotes a direction perpendicular thereto (cf. FIG. 6B). Accordingly, use can be made of rotationally symmetric, cylindrical, or anamorphic optics.

FIG. 6A illustrates aspects in the context of an integration of the optical system 110 with an interior trim panel 201 of a motor vehicle. What is shown here is that the imaging HOE 130 is arranged in a recess of the interior trim panel 201 in a manner flush with the interior trim panel 201, and the hologram 150—an on/off button in the illustrated example—is depicted in a volume in the interior of the motor vehicle in a manner offset from the surface of the interior trim panel 201.

Exemplary geometric dimensions for such an integration are listed below:

The floating height of the hologram 150—i.e., the distance 155; cf. FIG. 2—can be greater than 20 mm, for example 30 mm.

The reconstruction angle 135 (cf. FIG. 2) may typically be located in a range from 60° to 80°, for example at 70°.

By way of example, the substrate 132 of the imaging HOE 130 can be manufactured from glass and have a thickness 134 (plotted in FIG. 2) of 20 mm. This thickness 134 may also be chosen to be smaller in the case of a larger reconstruction angle 135 or a smaller lateral dimension 136 (also plotted in FIG. 2) of the refractive index-modulated region 131.

The distance between the light-shaping HOE 120 and the input coupling surface of the substrate 132 of the imaging HOE 130 is chosen such that the beam of light 90 from the light source 111 to the light-shaping HOE 120 is not curtailed by the substrate 132 of the imaging HOE 130 (bottom right corner of the substrate 132 in FIG. 2).

Further, it may be desirable for the distance from the light source 111 to the light-shaping HOE 120 to be chosen to be as large as possible such that the light source 111 has properties of a point light source to the best possible extent. At the same time, a larger area of the imaging HOE 130 can also be illuminated as a result of a greater distance between the light source 111, for example perpendicular to the plane of the drawing in FIG. 2 or along and/or perpendicular to the lateral dimension 136 (the corresponding depth direction is visible in FIG. 6B). Then again, the distance should not be chosen to be too large in order to shape as much light 90 of the light source 111 as possible in the vertical direction using the light-shaping HOE 120 (i.e., this corresponds to the height of the light-shaping HOE 120). For example, a range from 50 mm to 100 mm was identified as helpful for the distance, for example 70 mm in particular.

Thus, depending on the size of the lateral dimensions 136 of the imaging HOE 130, an illumination situation that is as optimal as possible can be set by way of the parameters of the reconstruction angle 135 of the imaging HOE 130 and the distance between the light source 111 and the light-shaping HOE 120.

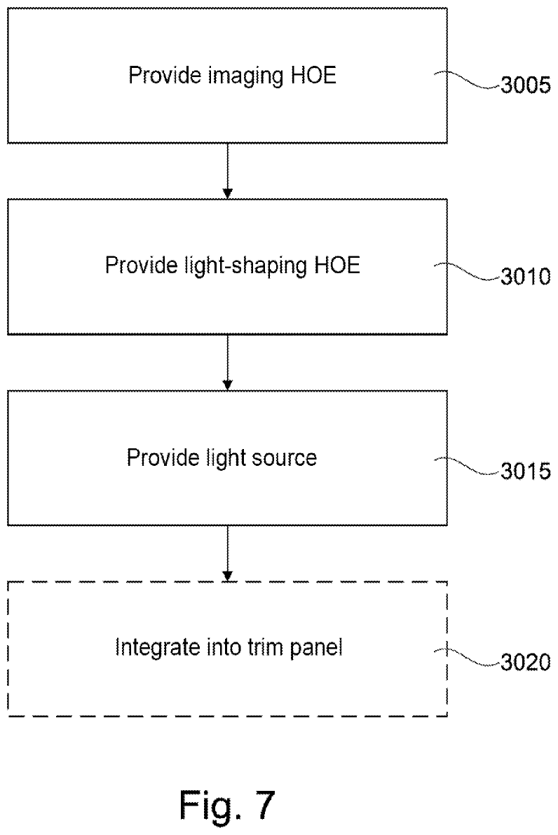

FIG. 7 shows a flowchart of an exemplary method for producing an optical system. By way of example, the optical system 110 according to any of the examples discussed hereinabove can be produced using the method of FIG. 7. Optional blocks are depicted using dashed lines in FIG. 7.

There initially is a provision of an imaging HOE in block 3005. For example, the imaging HOE 130 can be realized in accordance with the above-described examples.

For example, block 3005 could comprise an exposure of the imaging HOE 130 with reference light from a plurality of interfering laser light sources. The refractive index-modulated region can be formed on a corresponding substrate in this way. The reconstruction angle 135 is defined thereby.

In principle, a person skilled in the art is aware of the techniques for exposing an imaging HOE, with the result that no further details need to be specified here.

The provision of a light-shaping HOE is implemented in block 3010. For example, the light-shaping HOE 120 can be provided in accordance with the above-described examples.

Block 3010 can comprise the exposure of the light-shaping HOE 120 with reference light from a plurality of interfering laser light sources. In particular, the reflection angle of the light-shaping HOE can be defined thereby. The reflection angle corresponds to the illumination angle from one of the interfering laser light sources and this angle can be set to be equal to the Brewster angle of the light-shaping HOE.

In order to obtain the light-shaping functionalities discussed in tab. 1, the light-shaping HOE can be formed in reflection geometry in particular; however, a realization as a transmission HOE would also be possible in principle. A corresponding grating which diffracts and reflects incident light can provide a spectral filtering and filtering in the angular space, as discussed in tab 1. Moreover, what can be achieved by the suitable dimensions and arrangement of the light-shaping HOE in relation to the imaging HOE from block 3005 is that a homogeneous illumination of the refractive index-modulated region of the imaging HOE is obtained, especially in edge lit geometry.

A light source can be provided in block 3015. In particular, this light source can be arranged at a suitable distance from the light-shaping HOE.

Then, the integration of the optical system thus obtained into a trim panel, for example an interior trim panel of a motor vehicle, could be optionally implemented in block 3020.

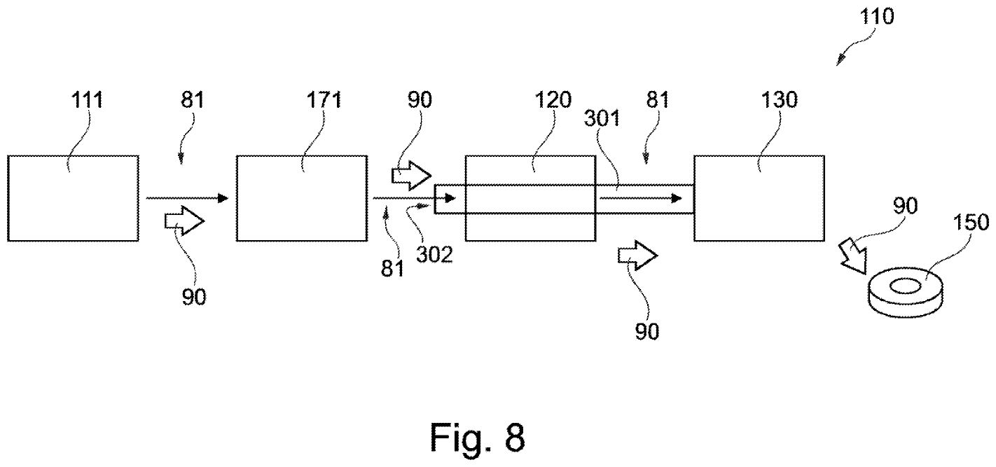

FIG. 8 illustrates aspects in connection with the optical system 110. FIG. 8 is a schematic illustration of the optical system 110, which is configured to generate a hologram 150. In principle, the optical system 110 from FIG. 8 corresponds to the optical system 110 from FIG. 1. However, the optical system 110 in FIG. 8 also comprises an optical waveguide 301. The optical waveguide 301 guides the beam path 81 of the light 90, formulated in general terms, to the imaging HOE 130. In the illustrated example, the optical waveguide 301 also guides the light 90 to the light-shaping HOE 120, and onward from the light-shaping HOE 120 to the imaging HOE 130. The optical wave-guide 301 can guide the light, for example by way of total-internal reflection at its interfaces, to the surrounding optically thinner medium.

This means that an input coupling surface 302 of the optical waveguide 301 is arranged between the refractive or mirror-optical element 171, for example a collimator lens, and the light-shaping HOE 120. For example, if use is made of a refractive collimator lens, then the input coupling surface 302 could be oriented perpendicular to the optical axis of the collimator lens.

However, it would in principle also be conceivable that the input coupling surface 302 is for example arranged between the light-shaping HOE 120 and the imaging HOE 130.

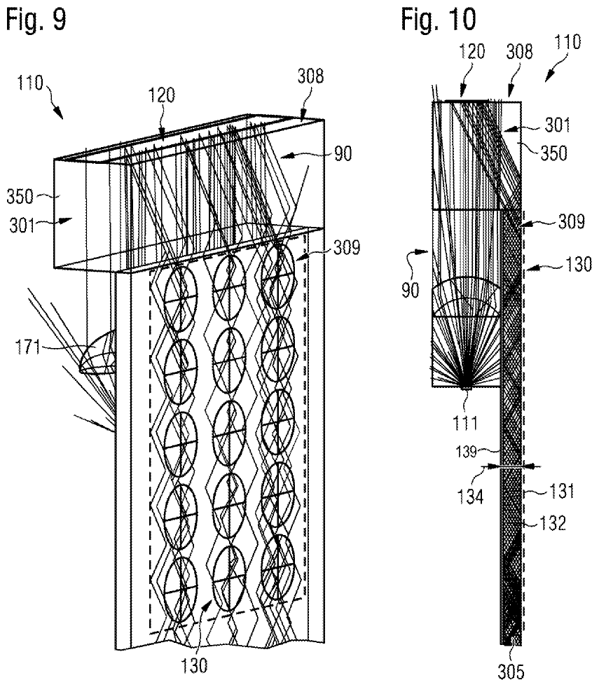

A particularly compact structure of the optical system 110 can be enabled by the use of the optical waveguide 310. By way of example, the optical waveguide 301 can realize the substrate 132 on which the imaging HOE 130 is arranged. By guiding the light 90 in the optical wave-guide 301 and along the refractive index-modulated region 131, it is thus possible to dimension the thickness 134 of the substrate 132 or optical waveguide 301 to be comparatively small (e.g., in comparison with the scenario of FIG. 2). Such a scenario is depicted in FIG. 9 and FIG. 10 for an exemplary structural realization.

FIG. 9 is a perspective view of an exemplary structural realization of the optical system 110 from FIG. 8 with the optical waveguide 301. FIG. 10 is a side view of the structural realization of the optical system 110 from FIG. 9.

It is evident from FIG. 9 and FIG. 10 that the optical waveguide 301 is formed from bulk material, for example glass or plastic. The optical waveguide 301 can be realized as an optical block 350. The light-shaping HOE 120 is applied to an outer surface 308 of the optical waveguide 301, and the imaging HOE 130 is applied to an outer surface 309 of the optical waveguide 301 perpendicular thereto. In general, the light-shaping HOE 120 and the imaging HOE 130 can be arranged on different outer surfaces.

It is evident from FIG. 9 that (unlike in FIG. 2) the light is incident on the refractive index-modulated region 131 of the imaging HOE 130 multiple times as a result of reflection in the optical waveguide 301, because the optical waveguide 301 extends below the imaging HOE 130 and realizes the substrate thereof. Hence, the thickness 134 is many times smaller than the lateral dimension 136, or in particular the length along the optical waveguide 301. In general, the thickness 134 may be no greater than 20% of the length of the imaging HOE 130 along the optical waveguide 301.

The beam cross section of the light 90 can also be reduced together with a reduced thickness 134. Hence, the lateral extent of the light-shaping HOE 120 can be reduced, making the design of the optical system 110 even more compact.

Realizations in which the optical system 110 has a single optical channel 31 were described hereinabove. This means that a single beam path 81 is provided for generating the hologram 150. Realizations in which the optical system 110 has more than a single optical channel are also conceivable. Exemplary implementations are explained in the context of the following figures.

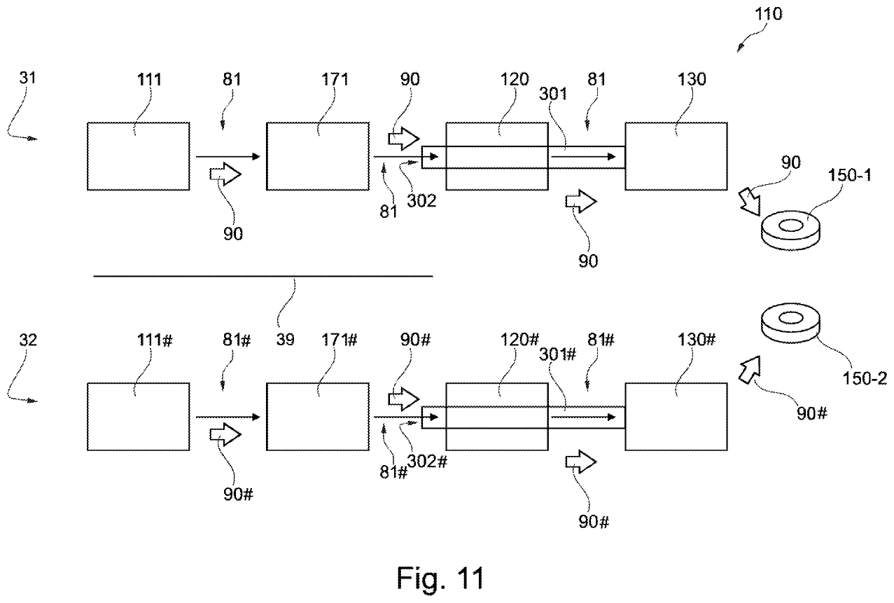

FIG. 11 illustrates aspects in connection with an optical system 110. FIG. 11 is a schematic illustration of the optical system 110, which is configured to generate a hologram 150. The optical system 110 in the example of FIG. 11 comprises two optical channels 31, 32.

The optical channel 31 corresponds to the example of FIG. 8 and was already discussed in the context of FIG. 8.

The optical system 110 also still comprises the further optical channel 32. The latter is realized in a manner analogous to the optical channel 31, which is to say it comprises a light source 111#, a light-shaping HOE 171#, and an optical waveguide 301# with a corresponding input coupling surface 302#.

Optionally, the optical system 110 may also comprise a stop element 39, which is arranged between the optical channels 31, 32 and avoids crosstalk of light between the optical channels 31, 32. The stop element 39 can be manufactured from light-absorbing material. The stop element 39 can for example extend between the respective light sources 111, 111#, up to the collimator lenses 171, 171# (or in general to the refractive or mirror-optical elements as discussed hereinabove). The stop can be dispensable following the collimation.

The optical channels 31, 32 are configured accordingly in FIG. 11. Formulated in general terms, it is possible that the optical channels 31, 32 are configured differently in relation to the arrangement and/or presence of optical elements. A few exemplary variations are listed below:

First variation: For example, it is possible to dispense with the optical waveguide 301 and/or the optical waveguide 301#—in a manner comparable to the optical channel 31 in the scenario of FIG. 1.

Second variation: While FIG. 11 and the subsequent figures each show two optical channels 31, 32, it would in principle be possible to realize a greater number of optical channels.

Third variation: It would also be conceivable that a common light source is used to transmit light both along the beam path 81 of the optical channel 31 and along the beam path 81# of the optical channel 32 (separate light sources 111, 111# are used in the depicted example of FIG. 11, with the result that different light 90, 90# is used for the beam path 81 and in the beam path 81#).

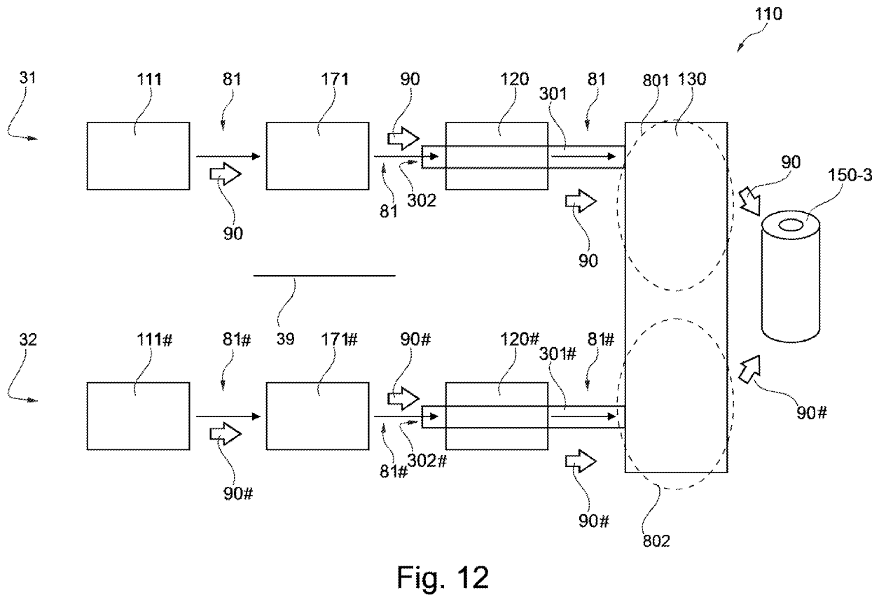

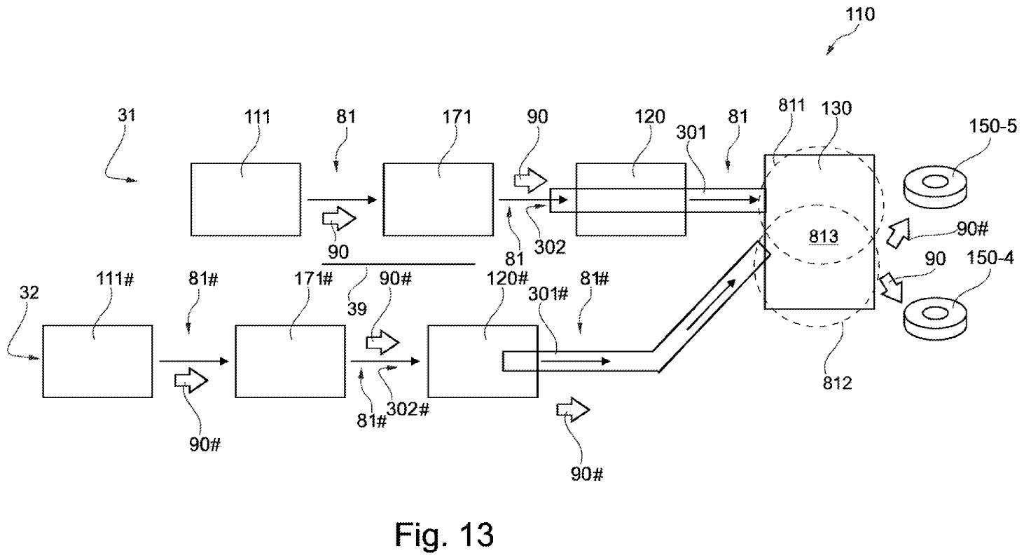

Fourth variation: In the example of FIG. 11, the optical channels 31, 32 address different imaging HOEs 130, 130#, which each generate a corresponding hologram 150-1, 150-2 by means of the light 90, 90#. However, variants in which the optical channels 31, 32 address the same imaging HOE 130, for example in different or overlapping regions, would also be conceivable. Such examples are shown in FIG. 12 and FIG. 13.

In the example of FIG. 12, the first optical channel 31 is configured to illuminate the region 801 of the imaging HOE with light 90, and the second optical channel 32 is configured to illuminate the region 802 of the imaging HOE 130 with light 90#. The region 801 and the region 802 are arranged next to one another. As a result, it is possible that a common image motif in the form of the hologram 150-3 is reconstructed by means of the light 90 and light 90# if both optical channels 31, 32 are activated simultaneously. The corresponding image motif can have a particularly large-area embodiment.

Instead of such a realization as shown in FIG. 12, in which adjacently arranged regions 801, 802 are addressed by the two optical channels 31, 32, it would also be conceivable that the optical channel 31 illuminates a first region of the imaging HOE 130 with the light 90 and the optical channel 32 illuminates a second region of the imaging HOE 130 with the light 90#, with the first region and the second region having a common overlap region. Such an example is depicted in FIG. 13.

In the example of FIG. 13, the optical channel 31 is thus configured to illuminate the region 811 of the imaging HOE 130 with light 90, and the optical channel 32 is configured to illuminate the region 812 of the imaging HOE 130 with light 90#. The region 801 and the region 802 have an overlap region 813, which is thus served by both optical channels.

In the illustrated example of FIG. 13, the light 90 is used to generate an image motif within the scope of the hologram 150-4, and the light 90# is used to generate an image motif within the scope of the hologram 150-5. These image motifs can be arranged in the same spatial region (this is not represented in the schematic view of FIG. 13).

This allows changing image motifs to be displayed at the same position, depending on which optical channel 31, 32 is activated. It is also possible to realize image motifs with different colors in one region (if the light 90 and the light 90# use different wavelengths for the reconstruction). Such a geometry is particularly advantageous since this allows the image motifs to be separated both in terms of wavelength and in terms of reconstruction angle, and this makes it possible to avoid crosstalk between the optical channels. It would also be conceivable to incrementally switch the brightness by the addition of individual optical channels (with the same image motif and color).

A corresponding separation of the optical channels—in order to generate different holograms 150-4, 150-5—can be realized in different ways. For example, different reconstruction angles are used for the light 90 and the light 90# in the example of FIG. 13. This means that the light 90 and the light 90# are incident on the imaging HOE 130 at different angles.

In principle, it would be possible, as an alternative or in addition, for the different optical channels to be associated with light at different wavelengths. For example, the light source 111 of the optical channel 31 could be configured to transmit the light 90 with a first emission spectrum and the light source 111# of the optical channel 32 can be configured to transmit the light 90# with a second emission spectrum. The emission spectra may differ from one another. This allows the image motifs of the holograms 150-4, 150-5 to be displayed in different colors, even in the same spatial region. Crosstalk can be avoided. As an alternative or in addition, it would be conceivable to display the holograms 150-4, 150-5 with a spatial offset.

It would also be conceivable that the emission spectra overlap at least in part in a further variant. If desired, a separation of the wavelength ranges could then be implemented by means of the light-shaping HOEs 120, 120#. For example, the spectral filtering of the light-shaping HOE 120 of the optical channel 31 could let a portion of the light 90 in a first wavelength range pass and the spectral filtering of the light-shaping HOE 120# of the optical channel 32 could let a portion of the light 90# in a second wavelength range pass, with the first wavelength range differing from the second wavelength range. This allows the image motifs of the holograms 150-4, 150-5 to be displayed in different colors, even in the same spatial region. Crosstalk can be avoided. As an alternative or in addition, it would be conceivable to display the holograms 150-4, 150-5 with a spatial offset.

Exemplary structural realizations of optical systems 110 with a plurality of optical channels are discussed hereinafter.

FIG. 14 is a perspective view with three optical channels 31, 32, 33, which have beam paths 81, 81# and 81##, respectively, running parallel to one another. Light-guiding elements 301, 301#, 301##, which are in the form of a joint optical block 350, are used. The collimator lenses 171, 171#, 171## are also integrally formed, as a lens array. For example, the collimator lenses 171, 171#, 171## could be produced in a joint injection molding process or in a joint 3-D printing process.

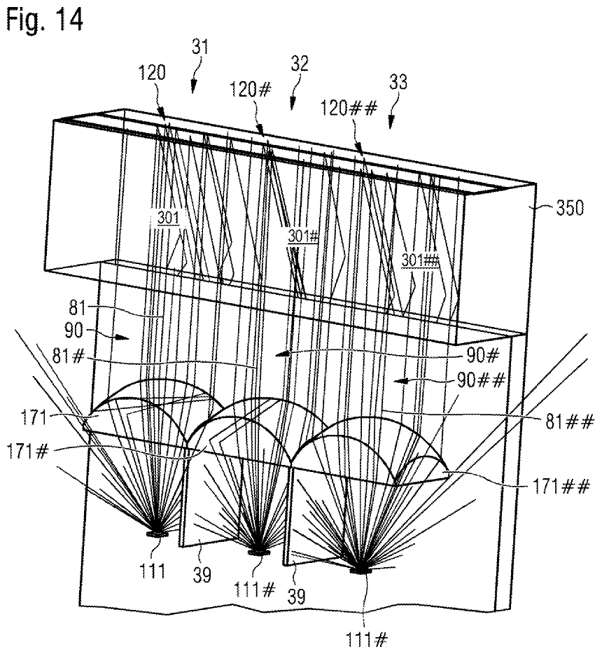

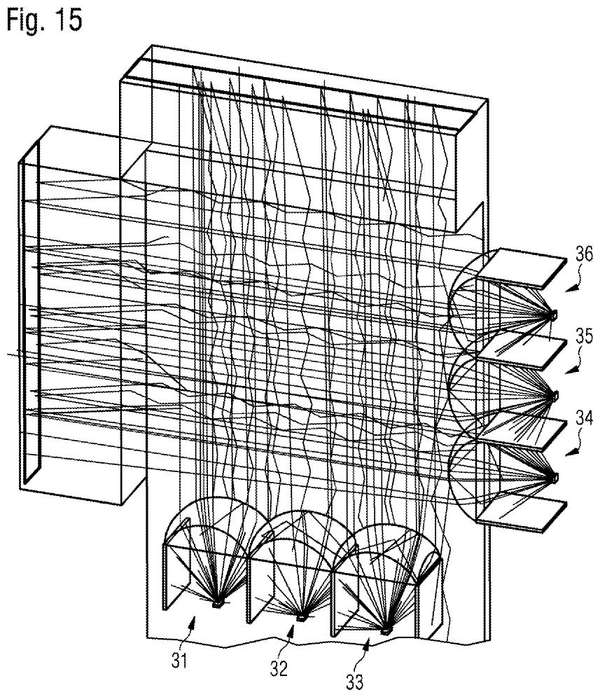

FIG. 15 is an enhancement of the example of FIG. 14. A total of six optical channels 31-36 are used in FIG. 15, wherein the optical channels 31-33 and 34-36 are respectively arranged perpendicular to one another (i.e., the corresponding beam paths form an angle of 90° with respect to one another). The channels 31-33 correspond to the example of FIG. 14; the channels 34-36 also correspond to the example of FIG. 14.

In this way, it is possible to form a line-column array for different imaging HOEs 130 or at least for different regions of a common imaging HOE. A line-column array of different image motifs could be reconstructed.

As a general rule, the beam paths of the various optical channels could form different angles with respect to one another, for example ranging from 45° to 90°.

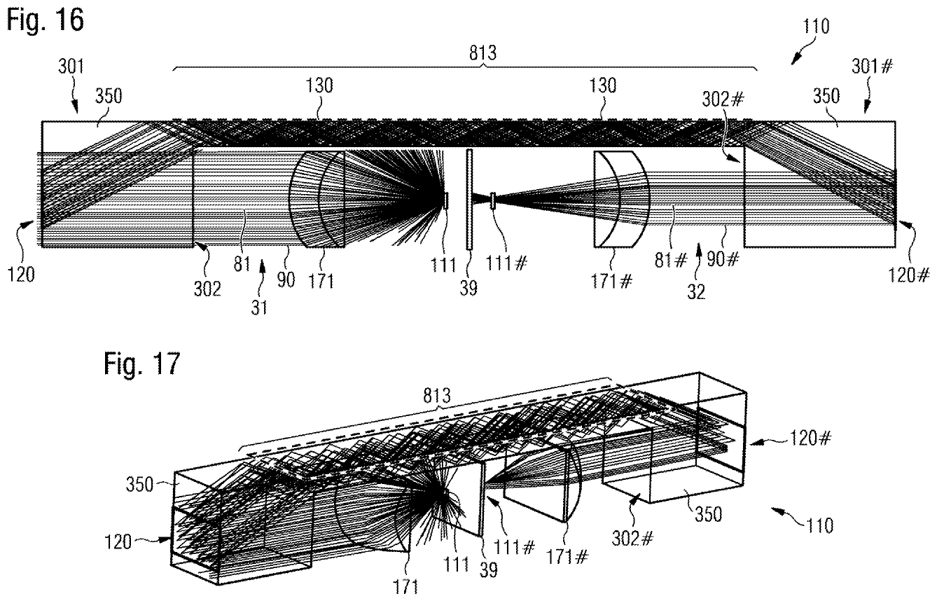

FIG. 16 is a further example of a possible implementation of the optical system 110 with two optical channels 31, 32, the beam paths 81, 81# of which run parallel to one another, to be precise at an angle of 180° with respect to one another. Hence, the reconstruction angles differ by 180° in the azimuthal direction. FIG. 17 is a corresponding perspective view of the optical sys- tem from FIG. 16.

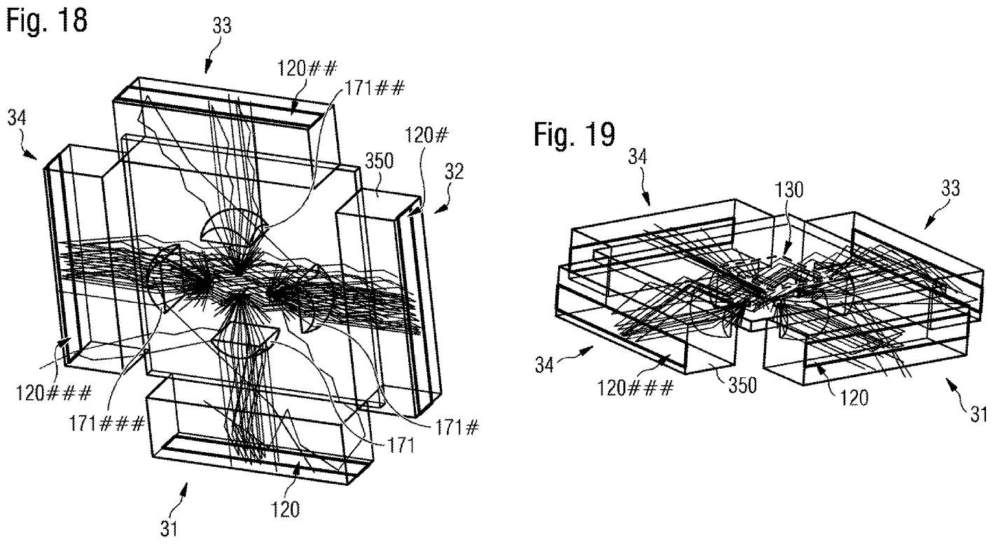

FIG. 18 and FIG. 19 show an optical system 110 in two different perspective views, the system being an enhancement of the optical system 110 from FIG. 16 and FIG. 17. The optical system 110 in FIG. 18 and FIG. 19 uses four optical channels 31-34, wherein two respective channels have beam paths that run parallel to one another and respectively correspond to the optical system 110 from FIG. 16 or FIG. 17.

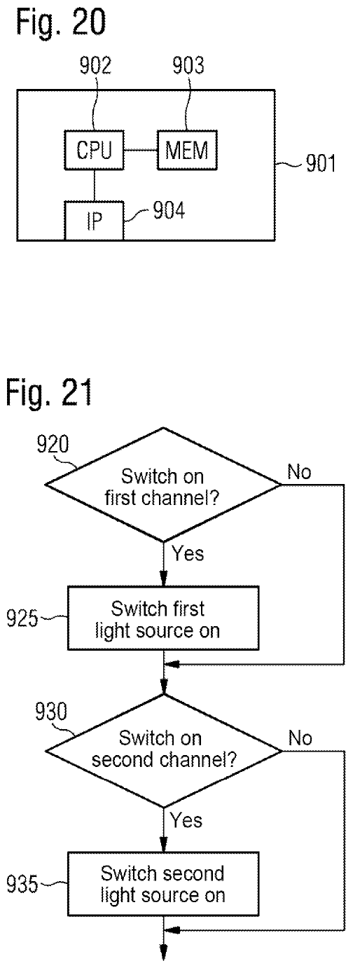

FIG. 20 schematically illustrates a controller according to various examples. FIG. 20 shows a data processing apparatus 901, which comprises a processor 902 and a memory 903. The data processing apparatus 901 realizes the controller, which is able to control a plurality of optical channels of an optical device as described above. To this end, the processor 902 can load and execute program code from the memory 903. Then, the processor 902 is able to separately switch individual light sources associated with different optical channels of the optical device on and off, by virtue of appropriate instructions being output via an interface 904. Thus, the processor 902 is able to control a plurality of light sources from different channels, optionally in separate or joint fashion.

An exemplary method for controlling an optical device is described below in the context of FIG. 21.

FIG. 21 is a flowchart of an exemplary method. The method of FIG. 21 serves to control an optical device having a plurality of optical channels. For example, the optical device 110 can be controlled as described above.

The method of FIG. 21 could be carried out by a controller, for example by the processor 902 of the data processing apparatus 901, on the basis of the program code from the memory 903 (cf. FIG. 20).

A check as to whether a first optical channel should be switched on is carried out in box 920. For example, a check as to whether a specific image motif of a floating hologram should be displayed could be carried out to this end, wherein the image motif intended for display is generated by the first optical channel. To this end, it is possible to take account of a motif specification —which is obtained from a display controller or a user input, for example. For example, if different imaging HOEs 130, 130# are addressed by the different optical channels (cf. FIG. 11), different buttons or image parts, for example, can be switched on/off in this way.

A check could also be carried out as to whether there is a brightness specification for a specific image motif of the floating hologram. More or fewer optical channels can be activated, depending on the brightness specification. By way of example, a decision to the effect that the first optical channel need not be switched on could be made in the case of a low brightness specification. This is especially helpful if the same hologram is reconstructed in the same spatial region by the plurality of optical channels (cf. FIG. 13).

Should the first optical channel be switched on, a first light source, which is associated with the first optical channel, is switched on in box 925.

A check corresponding to the check in box 920 is implemented in box 930, albeit for a further optical channel. Box 935 then corresponds to box 925 again, albeit for the further optical channel. Thus, the optical channels can be controlled on an individual basis.

It goes without saying that the features of the embodiments and aspects of the invention described above can be combined with one another. In particular, the features can be used not only in the combinations described but also in other combinations or on their own, without departing from the scope of the invention.

1. An optical system, comprising:
an imaging holographic optical element, HOE, configured to generate a floating hologram arranged in a volume outside of the imaging HOE on the basis of light,
a light source configured to transmit the light along a beam path to the imaging HOE, and
a light-shaping HOE arranged in the beam path between the light source and the imaging HOE and configured to perform spectral filtering of the light.

2. The optical system as claimed in claim 1, furthermore comprising:
an optical waveguide which guides the beam path to the imaging HOE.

3. The optical system as claimed in claim 2, furthermore comprising:
a refractive or mirror-optical optical element arranged in the beam path between the light source and the light-shaping HOE and configured to collect the light transmitted by the light source on the light-shaping HOE,
wherein an input coupling surface of the optical waveguide is arranged between the refractive or mirror-optical element and the light-shaping HOE.

4. The optical system as claimed in claim 2,
wherein the light-shaping HOE and the imaging HOE are applied to different outer surfaces of the optical waveguide.

5. The optical system as claimed in claim 2,
wherein the optical waveguide extends below the imaging HOE and realizes a substrate for a refractive index-modulated region of the imaging HOE.

6. (canceled)

7. The optical system as claimed in claim 1, furthermore comprising:
a first optical channel defined by the beam path,
a second optical channel defined by a further beam path, along which further light propagates to the imaging HOE or to a further imaging HOE.

8. The optical system as claimed in claim 7,
wherein the beam path of the first optical channel and the further beam path of the second optical channel run parallel to one another, or
wherein the beam path of the first optical channel and the further beam path of the second optical channel form an angle in the range of 45° to 90° with respect to one another.

9. The optical system as claimed in claim 7,
wherein the first optical channel is configured to illuminate a first region of the imaging HOE with the light,
wherein the second optical channel is configured to illuminate a second region of the imaging HOE with the further light,
wherein the first region and the second region have a common overlap region.

10. The optical system as claimed in claim 9,
wherein the first optical channel is configured to illuminate the overlap region with the light at a first reconstruction angle,
wherein the second optical channel is configured to illuminate the overlap region with the further light at a second reconstruction angle,
wherein the first reconstruction angle differs from the second reconstruction angle.

11. The optical system as claimed in claim 7,
wherein the first optical channel is configured to illuminate a first region of the imaging HOE with the light,
wherein the second optical channel is configured to illuminate a second region of the imaging HOE with the further light,
wherein the first region and the second region are arranged next to one another.

12. (canceled)

13. The optical system as claimed in claim 7, furthermore comprising:
a further light source configured to transmit the further light along the further beam path,
wherein the light source is configured to transmit the light with a first emission spectrum,
wherein the further light source is configured to transmit the further light with a second emission spectrum,
wherein the first emission spectrum and the second emission spectrum do not overlap.

14. The optical system as claimed in claim 7, furthermore comprising:
a further light source configured to transmit the further light along the further beam path,
wherein the light source is configured to transmit the light with a first emission spectrum,
wherein the further light source is configured to transmit the further light with a second emission spectrum,
wherein the first emission spectrum and the second emission spectrum overlap at least in part.

15. The optical system as claimed in claim 14, furthermore comprising:
a further light-shaping HOE arranged in the further beam path between the further light source and the imaging HOE or a further imaging HOE and configured to perform spectral filtering of the further light,
wherein the spectral filtering of the light-shaping HOE in the first optical channel allows a portion of the light in a first wavelength range to pass,
wherein the spectral filtering of the further light-shaping HOE in the second optical channel allows a portion of the further light in a second wavelength range to pass,
wherein the first wavelength range differs from the second wavelength range.

16. The optical system as claimed in claim 7,
wherein the first optical channel furthermore comprises: a refractive or mirror-optical optical element configured to collect the light,
wherein the second optical channel furthermore comprises: a further refractive or mirror-optical optical element configured to collect the further light,
wherein the refractive or mirror-optical optical element and the further refractive or mirror-optical optical element are integrally formed.

17. The optical system as claimed in claim 7, furthermore comprising:
a stop element arranged to separate the light of the first optical channel from the further light of the second optical channel.

18. (canceled)

19. The optical system as claimed in claim 7,
a controller is configured to separately or jointly control the light source of the first optical channel and the further light source of the second optical channel on the basis of at least one of a brightness specification of an image motif of the floating hologram or a motif specification of an image motif of the floating hologram.

20. (canceled)

21. The optical system as claimed in claim 1,
wherein the light-shaping HOE is furthermore configured to perform at least one of the following function: (i) reduce an angular spectrum with which the light propagates along the beam path, or (ii) deflect the light along the beam path to the imaging HOE.

22. (canceled)

23. The optical system as claimed in claim 21,
wherein the light-shaping HOE deflects the light along the beam path in reflection geometry,
wherein a reflection angle, at which the light-shaping HOE reflects the light along the beam path corresponds to the Brewster angle of a material of the substrate of the light-shaping HOE.

24. (canceled)

25. The optical system as claimed in any of claims 21,
wherein an angle of incidence of the light along the beam path on the light-shaping HOE is chosen such that Fresnel reflections of the light are oriented away from the imaging HOE.

26. (canceled)

27. The optical system as claimed in claim 1,
wherein the light source comprises a light-emitting diode with an emission spectrum,
wherein the spectral filtering of the light-shaping HOE allows a portion of the light in the range of up to 50% of a width of the emission spectrum to pass.

28. (canceled)

29. The optical system as claimed in claim 1,
wherein a distance between the volume and the imaging HOE is no less than 60% of a lateral dimension of a refractive index-modulated region of the imaging HOE.

30. A method for producing an optical system, wherein the method comprises:
providing an imaging holographic optical element, HOE, configured to generate a floating hologram arranged in a volume outside of the imaging HOE on the basis of light,
providing a light source configured to transmit the light along a beam path to the imaging HOE, and
providing a light-shaping HOE arranged in the beam path between the light source and the imaging HOE and configured to perform spectral filtering of the light.
